(19) United States
(12) Patent Application Publication
(10) Pub. No.: US 2021/0094129 A1
(43) Pub. Date: Apr. 1, 2021

(54) METHOD OF CONSTRUCTING VEHICLE

(71) Applicant: International Truck Intellectual Property Company, LLC, Lisie, IL (US)

(72) Inventors: Peter Wong, Naperville, IL (US); Aditya Rajderkar, Hoffman Estates, IL (US); Hector Kiely, Plainfield, IL (US)

(73) Assignee: International Truck Intellectual Property Company, LLC, Lisle, IL (US)

(21) Appl. No.: 16/583,883

(22) Filed: Sep. 26, 2019

(51) Int. Cl. B23K 28/02; B62D 27/02; B62D 25/06; B62D 25/20; B62D 31/02; B62D 65/02

(52) U.S. Cl. CPC B23K 28/02; B62D 27/02; B62D 25/06; B23K 2103/04; B62D 31/02; B62D 65/024; B62D 25/20

(57) ABSTRACT

Embodiments disclosed herein relate to a method of constructing a vehicle. In one embodiment, a length and a width of the vehicle are determined. Material is cut into a first sheet equal to the length of the vehicle, and a second sheet equal to the length of the vehicle. A joint couples the first sheet and the second sheet to form the width of the vehicle.

### BACKGROUND

This disclosure relates generally a method of constructing a vehicle. More specifically, this disclosure relates to a school bus and to a method of constructing a school bus.

Some currently available vehicles include a floor 10 comprising a plurality of pieces of material typically cut into sheets 12 having a width substantially equal to a width of a vehicle. For instance, as shown in FIG. 1, some currently available school buses comprise a plurality of sheets 12 of material, often steel and the like, substantially equal to a width of the school bus. Because a school bus has a length often larger than its width, a plurality of such sheets 12 are assembled together substantially perpendicularly to a longitudinal axis of the school bus. Each pair of the plurality of sheets 12 of material are joined together. In the embodiment illustrated in FIG. 1, there are twelve (12) joints 14. Each of such joints 14 must comply with requirements included in 49 CFR § 571.221 that applies to school bus body joint strength. These requirements are intended to reduce deaths and injuries resulting from structural collapse of school bus bodies during crashes. Additionally, the plurality of sheets 12 itself can increase material cost, labor and compliance costs of a school bus. In light of these facts, it is desirable to provide an improved vehicle floor and an improved method of constructing a vehicle.

### SUMMARY

Embodiments disclosed herein relate to a method of constructing a vehicle. In one embodiment, a length and a width of the vehicle are determined. Material is cut into a first sheet equal to the length of the vehicle, and a second sheet equal to the length of the vehicle. A joint couples the first sheet and the second sheet to form the width of the vehicle.

### DESCRIPTION OF THE DRAWINGS

FIG. 1 is a perspective view of a vehicle floor of the PRIOR ART; and

FIG. 2 is a perspective view of a vehicle floor described herein.

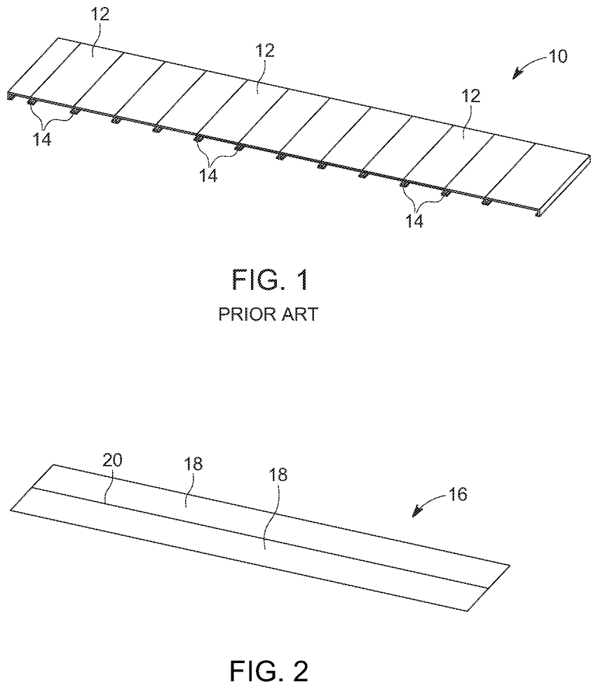

### DETAILED DESCRIPTION

This disclosure relates to an improved vehicle floor 16 and an improved method of constructing a vehicle. As shown in FIG. 2, a vehicle floor 16 comprises a number of sheets 18 of material, such as steel and the like. The sheets 18 are formed, cut, or the like to a length substantially equal to a length of the vehicle. In the embodiment shown in FIG. 2, there are two (2) such sheets 18. Because the sheets 18 are disposed along a longitudinal axis of the vehicle, length of the sheets 18 can accommodate any length of vehicle. The sheets 18 are coupled, such as by seam welding and the like, at a common edge to form a width of the vehicle. If the vehicle is a school bus, then the common edge comprises joint 20 that complies with 49 CFR § 571.221. In the illustrated embodiment, there is one (1) joint 20. The joint 20 couples the sheets 18 together thereby forming one (1) piece substantially equal to the width of the vehicle.

In another embodiment, the sheets 18 are disposed such that a portion of one sheet 18 overlaps a portion of another sheet 18. The joint 20 comprises a segment of the sheets 18 that overlap each other. Binding, such as a spot weld and the like, can be located substantially centrally along the segment thereby coupling the sheets together to form one (1) piece substantially equal to the width of the vehicle.

While embodiments disclosed herein focus on a vehicle floor, it is to be understood that teachings of these embodiments may be applied in other elements of a vehicle, such as an exterior roof of the vehicle, an interior overhead lining of the vehicle, and the like, that varies by length of vehicle. Some vehicles may comprise many elements manufactured using embodiments disclosed herein.

Utilization of the above-discussed embodiments provide for an improved method of constructing a vehicle. A length of the vehicle is determined. A width of the vehicle is determined. Material is cut into a first sheet equal to the length of the vehicle. Material is cut into a second sheet equal to the length of the vehicle. A joint coupling the first sheet and the second sheet to form the width of the vehicle. If the vehicle is a school bus, then the joint complies with 49 CFR § 571.221. Using this method may reduce labor constructing a vehicle, facilitate automated assembly of a vehicle, reduce material waste, improve dimensional quality for sheets of material and the like.

What is claimed is:

1. A method of constructing a vehicle, the method comprising the steps of:
determining a length of the vehicle;
determining a width of the vehicle;
cutting material into a first sheet equal to the length of the vehicle;
cutting material into a second sheet equal to the length of the vehicle;
a joint coupling the first sheet and the second sheet to form the width of the vehicle.

2. The method of claim 1 wherein the vehicle is a school bus.

3. The method of claim 1 wherein the joint is formed by seam welding.

4. The method of claim 1 wherein the joint complies with 49 CFR § 571.221.

5. The method of claim 1 wherein the first sheet and the second sheet comprise an exterior roof of the vehicle.

6. The method of claim 1 wherein the first sheet and the second sheet comprise at least one of a floor of the vehicle, an exterior roof of the vehicle, and an interior overhead lining of the vehicle.
